(19) United States
(12) Patent Application Publication
(10) Pub. No.: US 2024/0425413 A1
(43) Pub. Date: Dec. 26, 2024

(54) POWDER DISPERSANT COMPOSITION FOR HYDRAULIC COMPOSITIONS

(71) Applicant: KAO CORPORATION, Tokyo (JP)

(72) Inventors: Kohei SHIMADA, Wakayama-shi, Wakayama (JP); Keiichirou SAGAWA, Wakayama-shi, Wakayama (JP)

(73) Assignee: KAO CORPORATION, Tokyo (JP)

(21) Appl. No.: 18/274,034

(22) PCT Filed: Feb. 22, 2022
(86) PCT No.: PCT/JP2022/007341

§ 371 Date: Jul. 25, 2023

(30) Foreign Application Priority Data
Mar. 1, 2021 (JP) 2021-031647

(51) Int. Cl. C04B 24/26; C04B 14/06; C04B 28/04; C04B 40/00; C04B 103/40

(52) U.S. Cl. CPC C04B 24/2647; C04B 14/062; C04B 28/04; C04B 40/0039; C04B 2103/408

(57) ABSTRACT

Provided is a powder dispersant composition for hydraulic compositions containing particles (A) and (B). An aqueous solution or aqueous suspension of the powder dispersant composition at a concentration of 5 mass % has a surface tension of 20.0 mN/m to 50.0 mN/m at 25° C. Particle (A) contains components (A1) and (A2) and has a D50 of 90 μm to 600 μm, wherein a proportion of particles of 70 μm or less is 15 volume % or less. Component (A1) is a copolymer of constituent units (1) and (2), wherein all the raw material monomers of the copolymer have a melting point of −80° C. to 80° C. Component (A2) is a nonionic surfactant, whose aqueous solution or aqueous suspension at a concentration of 5 mass % has a surface tension of 20.0 mN/m to 50.0 mN/m at 25° C. Particle (B) is formed of an inorganic compound and has a D50 of 1 μm to 50 μm.

### FIELD OF THE INVENTION

The present invention relates to a powder dispersant composition for hydraulic compositions, a premix for hydraulic compositions and a hydraulic composition.

### BACKGROUND OF THE INVENTION

In recent years, in order to realize the SDGs, eco-friendly infrastructure development has been aimed at from an ESG perspective. As one example thereof, construction of new offshore wind turbines to utilize renewable energy or maintenance and repair of infrastructure established during the period of rapid economic growth has been carried out actively.

In that field, the use of premixes, which are powder mixture products of hydraulic compositions and organic compounds such as powdery dispersants (hereinafter referred to as powder dispersants) or the like, is mainstream as spaces for construction works are limited and it is difficult to bring in fresh concrete. Powder dispersants that are premixed in repair materials include naphthalene sulfonic acid-based dispersants, polycarboxylic acid-based dispersants, melamine sulfonic acid-based dispersants and others, but in particular, polycarboxylic acid-based dispersants show high dispersibility, resulting in a reduced formulation amount of water in hydraulic compositions, thereby contributing to improvement of the strength of constructions.

Meanwhile, powder dispersants are obtained by drying dispersant solutions, and powdering methods are divided broadly into a heat drying method in which heat drying is carried out at normal temperature and pressure, and a reduced-pressure drying method in which drying is carried out under reduced pressures, and are classified into a thin-film drying method represented by a drum drying method, a disc drying method and a belt drying method, a spray drying method, a kneader method, an inorganic powder supporting method or the like according to the method for developing a dispersant solution.

Further, powder dispersant compositions for hydraulic compositions represented by powder dispersants are often mixed with inorganic powders such as amorphous silica, calcium carbonate fine powder, blast furnace slag fine powder or the like for the purpose of improving anti-solidifying properties and handleability.

WO-A 2006/059723 discloses a powdered polycarboxylic acid-based cement dispersant containing a polyamide-polyamine in a skeleton of a polymer thereof and a dispersant composition containing the dispersant, the dispersant having improved water reducing ability, slump-flow retention, and strength-developing properties of concrete, enabling effective prevention of blocking, being highly soluble in a slurry, and being homogeneously mixed with an inorganic powder.

### SUMMARY OF THE INVENTION

However, general powder dispersant compositions for hydraulic compositions, which often contain thermoplastic macromolecules, are more likely to cause melting or fusion under high temperature environments, resulting in reduced handleability of powder dispersant compositions for hydraulic compositions. In short, they have problems in thermostability. Further, it is desirable that powder dispersant compositions for hydraulic compositions be able to impart excellent fluidity to hydraulic compositions, for example, even if used in the form of powders such as premixes to prepare hydraulic compositions, or the like.

The present invention provides a powder dispersant composition for hydraulic compositions which is able to impart excellent fluidity to hydraulic compositions, and is excellent in thermostability, such as being less likely to solidify even under high temperature environments, or the like.

The present invention relates to a powder dispersant composition for hydraulic compositions containing the following particles (A) and (B), wherein an aqueous solution or aqueous suspension of the powder dispersant composition for hydraulic compositions at a concentration of 5 mass % has a surface tension of 20.0 mN/m or more and 50.0 mN/m or less at 25° C.,

### <Particle (A)>

particles containing the following components (A1) and (A2) and having a median diameter (D50; μm) of 90 μm or more and 600 μm or less, wherein a proportion of particles with a particle size of 70 μm or less is 15 volume % or less,

### [Component (A1)]

a copolymer including constituent unit (1) represented by the following formula (1) and constituent unit (2) represented by the following formula (2), wherein all the raw material monomers of the copolymer have a melting point of −80° C. or more and 80° C. or less,

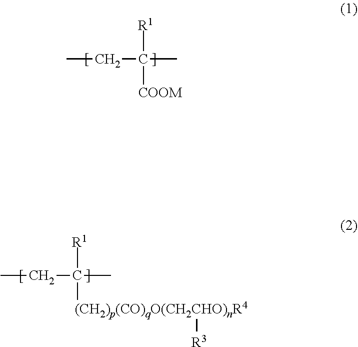

wherein R¹ and R³ are the same or different and each represent a hydrogen atom or a methyl group, R² and R⁴ are the same or different and each represent a hydrogen atom or an alkyl group with 1 or more and 3 or less carbons, M represents a hydrogen atom, an alkali metal, an alkaline earth metal, ammonium or an organic ammonium, p represents a number of 0 or more and 2 or less, q represents a number of 0 or 1, and n represents an average number of added moles and represents a number of 5 or more and 150 or less, and

### [Component (A2)]

a nonionic surfactant whose aqueous solution or aqueous suspension at a concentration of 5 mass % has a surface tension of 20.0 mN/m or more and 50.0 mN/m or less at 25° C., and

### <Particle (B)>

particles formed of an inorganic compound and having a median diameter (D50; μm) of 1 μm or more and 50 μm or less.

The powder dispersant composition for hydraulic compositions of the present invention includes a powder dispersant composition for hydraulic compositions containing the following particles (A) and (B), wherein an aqueous solution or aqueous suspension of the powder dispersant composition for hydraulic compositions at a concentration of 5 mass % has a surface tension of 20.0 mN/m or more and 50.0 mN/m or less at 25° C.,

### <Particle (A)>

particles containing the following components (A1) and (A2) and having a median diameter (D50; μm) of 90.0 μm or more and 600.0 μm or less, wherein a proportion of particles with a particle size of 70 μm or less is 15.0 volume % or less,

### [Component (A1)]

a copolymer including constituent unit (1) represented by the following formula (1) and constituent unit (2) represented by the following formula (2), wherein all the raw material monomers of the copolymer have a melting point of −80° C. or more and 80° C. or less,

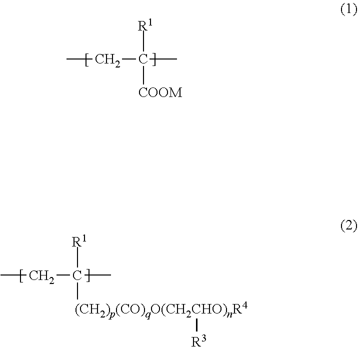

wherein R¹ and R³ are the same or different and each represent a hydrogen atom or a methyl group, R² and R⁴ are the same or different and each represent a hydrogen atom or an alkyl group with 1 or more and 3 or less carbons, M represents a hydrogen atom, an alkali metal, an alkaline earth metal, ammonium or an organic ammonium, p represents a number of 0 or more and 2 or less, q represents a number of 0 or 1, and n represents an average number of added moles and represents a number of 5 or more and 150 or less, and

### [Component (A2)]

a nonionic surfactant whose aqueous solution or aqueous suspension at a concentration of 5 mass % has a surface tension of 20.0 mN/m or more and 50.0 mN/m or less at 25° C., and

### <Particle (B)>

particles formed of an inorganic compound and having a median diameter (D50; μm) of 1.0 μm or more and 50.0 μm or less.

Further, the present invention relates to a premix for hydraulic compositions formulated with the powder dispersant composition for hydraulic compositions of the present invention, (C) one or more hydraulic powders selected from cement, gypsum, slag, fly ash and lime and (D) a fine aggregate.

Further, the present invention relates to a hydraulic composition formulated with the premix for hydraulic compositions of the present invention and water.

Further, the present invention relates to a method for producing the powder dispersant composition for hydraulic compositions of the present invention including, drying a mixture containing component (A1), component (A2) and water to produce particle (A), and mixing particle (A) with particle (B).

Further, the present invention relates to use of the composition of the present invention as a powder dispersant for hydraulic compositions.

According to the present invention, provided are a powder dispersant composition for hydraulic compositions which is able to impart excellent fluidity to hydraulic compositions, and is excellent in thermostability, such as being less likely to solidify even under high temperature environments, or the like, and a premix for hydraulic compositions and a hydraulic composition using the same.

### EMBODIMENTS OF THE INVENTION

In recent years, in order to realize a sustainable society, the SDGs have been advocated. We believe that the present invention, which can achieve improved storage stability of dispersant compositions, a labor-saving hydraulic powder mixing process during the production of hydraulic compositions and others, can be a technology which contributes to, for example, Nos. 7, 9, 11, 12, 13 or the like of the SDGs.

The present inventors found that anti-solidifying properties at high temperatures are improved by mixing a predetermined particle (A) with a predetermined particle (B), wherein particle (A) is obtained by combining a predetermined copolymer [component (A1)] with a predetermined nonionic surfactant [component (A2)], all the raw material monomers of component (A1) having a melting point falling within a predetermined range. The mechanism by which anti-solidifying properties at high temperatures are improved by the present invention is not wholly certain, but is inferred to be as follows. Among adhesive forces (cohesive attractive forces) between fine particles, liquid bridge force (the Laplace pressure) is known as one of the largest interactive forces. It is further considered that adhesive force between particles increases contact frequency of particles, and fusion of particles is thereby facilitated. In the present invention, it is considered that organic compounds which are more likely to cause fusion (the copolymer and an organic compound incorporated into particle (A) component other than that) have a reduced contact area therebetween as particle (A) itself has a relatively reduced surface area due to a relatively increased diameter of particle (A), and particle (A) is covered with particle (B) having a small particle size and a large surface area. Further, the nonionic surfactant combined in particle (A) is more likely to bleed on the surface of the organic compounds as the nonionic surfactant has a lower surface tension than the organic compounds, and has a low affinity with the copolymer compared to surfactants with high polarity such as anionic surfactants or the like. It is considered that this results in reduced surface tensions of the melted organic compounds or a liquid phase of moisture included in particle (A), reducing the Laplace pressure a controlling factor of which is surface tension, and further adhesive force, thereby improving anti-solidifying properties at high temperatures. It is considered that anti-solidifying properties by such a mechanism are more appropriately exhibited as the nonionic surfactant combined in particle (A) has a predetermined surface tension. Further, the mechanism by which hydraulic compositions using the powder dispersant composition for hydraulic compositions of the present invention are excellent in fluidity is not wholly certain, but is inferred to be as follows. Thermal properties of macromolecules are affected to no small extent by the stiffness of constituent units of macromolecules. To be more specific, macromolecules in which softer constituent units are polymerized tend to be softer. It is considered that, as soft molecules have relatively large molecular mobility, such a macromolecule, which serves, for example, as a dispersant, can keep the adsorption film thickness of the macromolecule thick even in hydraulic compositions, thereby imparting dispersing ability to hydraulic powder more effectively and increasing the apparent volume of free water, so that hydraulic compositions show excellent fluidity. It is inferred that such improved fluidity is more likely to be exhibited in the present invention as all the raw material monomers of the copolymer of component (A1) used in particle (A) have a relatively low melting point. Further, it is inferred that, with such a copolymer, fluidity is more likely to be improved as solubility or dispersibility in water is improved and fluidity is quickly exhibited under the same conditions.

Note that the acting mechanisms of the present invention are not limited to these.

### [Powder Dispersant Composition for Hydraulic Compositions]

The powder dispersant composition for hydraulic compositions of the present invention contains predetermined particles (A) and (B).

Particle (A) is particles containing the following components (A1) and (A2) and having a median diameter (D50; μm) of 90 μm or more and 600 μm or less, wherein a proportion of particles with a particle size of 70 μm or less is 15 volume % or less,

### [Component (A1)]

a copolymer including constituent unit (1) represented by the following formula (1) and constituent unit (2) represented by the following formula (2), wherein all the raw material monomers of the copolymer have a melting point of −80° C. or more and 80° C. or less,

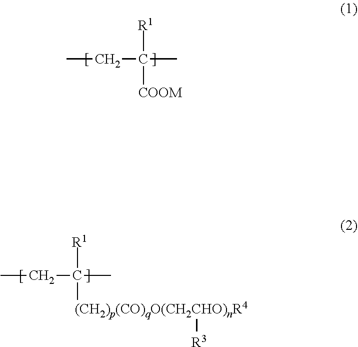

wherein R¹ and R³ are the same or different and each represent a hydrogen atom or a methyl group, R² and R⁴ are the same or different and each represent a hydrogen atom or an alkyl group with 1 or more and 3 or less carbons, M represents a hydrogen atom, an alkali metal, an alkaline earth metal, ammonium or an organic ammonium, p represents a number of 0 or more and 2 or less, q represents a number of 0 or 1, and n represents an average number of added moles and represents a number of 5 or more and 150 or less, and

### [Component (A2)]

a nonionic surfactant whose aqueous solution or aqueous suspension at a concentration of 5 mass % has a surface tension of 20.0 mN/m or more and 50.0 mN/m or less at 25° C.

All the raw material monomers of the copolymer of component (A1) have a melting point of −80° C. or more and 80° C. or less from the viewpoint of anti-solidifying properties at high temperatures. Here, a monomer means a monomer to be a constituent unit of a repeat unit of the copolymer. While this monomer may include a polymeric structure, a monomer constituting that polymeric portion is excluded from a monomer whose melting point is evaluated. For example, while constituent unit (2) includes a polymeric structure of an alkyleneoxide represented by (CH₂CH(R₃)O)ₙ in its structure, the alkyleneoxide, the monomer of this polymeric structure, is not considered as a monomer whose melting point is evaluated. Note that, if a sample is available as a reagent, a melting point disclosed in a safety data sheet (SDS) is employed as the melting point of a raw material monomer of the copolymer of component (A1). Further, if samples are unavailable as reagents, about 0.4 mg of each sample is weighed in a platinum pan and used for measurements with a simultaneous thermogravimetric-differential thermal analyzer (TG-DTA) (Thermo plus EV02, manufactured by Rigaku Corporation) under an N₂ atmosphere at 200 mL/minute under the temperature conditions below, and an endothermic peak temperature Tp (° C.) from differential thermal analysis (DTA) is used as a melting point.
[1] 30° C.→1,000° C. (10.0° C./minute)
[2] 1,000° C.→30° C. (−30.0° C./minute)

In one aspect of the present invention, all the raw material monomers of the copolymer of component (A1) have a melting point of preferably −65° C. or more, more preferably −30° C. or more and further preferably 5° C. or more, and preferably 75° C. or less, more preferably 70° C. or less and further preferably 65° C. or less from the viewpoint of anti-solidifying properties at high temperatures. Further, in another aspect of the present invention, numerical values selected from −80° C., −65° C., −30° C., 5° C. or more, 10° C., 20° C., 50° C., 65° C., 70° C., 75° C. and 80° C. can be combined and set as an upper limit and a lower limit of the range of the melting points of the raw material monomers. Further, a monomer to be constituent unit (1) preferably has a melting point of 5° C. or more and further 10° C. or more, and 20° C. or less. Further, a monomer to be constituent unit (2) preferably has a melting point of 50° C. or more and 65° C. or less. All the raw material monomers of the copolymer of component (A1) preferably have a melting point falling within the above range.

For constituent unit (1) represented by the formula (1), R¹ is a hydrogen atom or a methyl group, and preferably includes a methyl group. M is a hydrogen atom, an alkali metal, an alkaline earth metal, ammonium or an organic ammonium, and preferably an alkali metal or an alkaline earth metal. Constituent unit (1) may be two or more. Examples of a monomer to be constituent unit (1) include a monomer selected from acrylic acid, methacrylic acid and salts of them.

For constituent unit (2) represented by the formula (2), R² and R⁴ are the same or different and each represent a hydrogen atom or an alkyl group with 1 or more and 3 or less carbons from the viewpoint of reactivity, and each represent preferably an alkyl group with 1 carbon, i.e., a methyl group from the viewpoint of anti-solidifying properties at high temperatures. Further, R³ is a hydrogen atom or a methyl group and preferably a hydrogen atom from the viewpoint of anti-solidifying properties at high temperatures. Constituent unit (2) may be two or more. p represents a number of 0 or more and 2 or less, and is preferably 0 or more and 1 or less and more preferably 0 from the viewpoint of anti-solidifying properties at high temperatures. q represents a number of 0 or 1, and is preferably 1 from the viewpoint of thermostability. n is an average number of added moles, and represents a number of 5 or more and 150 or less. From the viewpoint of anti-solidifying properties at high temperatures, n is preferably 20 or more, more preferably 40 or more, further preferably 60 or more and furthermore preferably 100 or more, and n is preferably 140 or less, more preferably 130 or less and further preferably 120 or less. In another aspect of the present invention, the range of n may be 100 or more, and 150 or less, further 140 or less, further 130 or less and further 120 or less. Examples of a monomer to be constituent unit (2) include a monomer selected from methoxy polyethylene glycol monomethacrylate, polyoxyethylene methallyl ether, polyoxyethylene isoprenyl ether and polyoxyethylene vinyl ether.

Component (A1) preferably includes constituent unit (3) represented by the following formula (3) from the viewpoint of fluidity retaining performance:

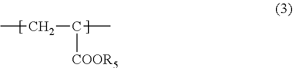

wherein R⁵ represents a hydrocarbon group with 1 or more and 4 or less carbons which may include hetero atoms.

R⁵ in the formula (3) represents a hydrocarbon group with 1 or more and 4 or less carbons which may include hetero atoms, and is preferably a hydroxyethyl group or a methyl group.

Constituent unit (3) is preferably a constituent unit with a compound selected from alkyl (with 1 or more and 4 or less carbons) acrylates and alkyl (with 1 or more and 4 or less carbons) methacrylates as a monomer.

Component (A1) is preferably a copolymer including constituent unit (1), constituent unit (2) and optionally constituent unit (3), wherein a proportion of constituent unit (1) is 45 mol % or more and 95 mol % or less, a proportion of constituent unit (2) is 5 mol % or more and 30 mol % or less, and a proportion of constituent unit (3) is 0 mol % or more and 35 mol % or less in a total of contents of constituent units (1) to (3) from the viewpoint of cement dispersibility. In the copolymer, a proportion of constituent unit (1) is preferably monomer 55 mol % or more and further 65 mol % or more, and 90 mol % or less and further 85 mol % or less in a total of contents of constituent units (1) to (3). In the copolymer, a proportion of constituent unit (2) is preferably monomer 10 mol % or more and further 15 mol % or more, and 25 mol& or less and further 20 mol % or less in a total of contents of constituent units (1) to (3). In the copolymer, a proportion of constituent unit (3) is preferably monomer 5 mol % or more and further 10 mol % or more, and 25 mol % or less and further 15 mol % or less in a total of contents of constituent units (1) to (3).

A molar ratio of constituent unit (1) to constituent unit (2) in component (A1), constituent unit (1)/constituent unit (2), is preferably 1 or more and more preferably 3 or more, and preferably 20 or less and more preferably 10 or less from the viewpoint of cement dispersibility.

A proportion of a total of constituent units (1) and (2) or a proportion of a total of constituent units (1), (2) and (3) in all the constituent units of component (A1) is preferably 80 mol % or more and more preferably 90 mol % or more, and preferably 100 mol& or less, and may be 100 mol %.

A weight average molecular weight of component (A1) is preferably 20,000 or more, more preferably 25,000 or more, further preferably 30,000 or more and furthermore preferably 35,000 or more, and preferably 70,000 or less, more preferably 60,000 or less and further preferably 55,000 or less from the viewpoint of cement dispersibility. This weight average molecular weight is measured by gel permeation chromatography (GPC) under the following conditions:

* GPC conditions
Instrument: GPC (HLC-8320GPC) manufactured by Tosoh Corporation
Column: G4000PWXL+G2500PWXL (manufactured by Tosoh Corporation)
Eluent: 0.2 M phosphate buffer/CH₃CN=9/1
Flow rate: 1.0 mL/min
Column temperature: 40° C.
Detection: RI
Sample size: 0.2 mg/mL
Standard substance: expressed in terms of polyethylene glycol (monodisperse polyethylene glycol: molecular weight 87,500, 250,000, 145,000, 46,000, 24,000).

Component (A2) is a nonionic surfactant whose aqueous solution or aqueous suspension at a concentration of 5 masse has a surface tension of 20.0 mN/m or more and 50.0 mN/m or less at 25° C. The above surface tension of component (A2) is measured by a du Noüy tensiometer described in JIS K-3362. In one aspect of the present invention, the above surface tension of component (A2) is preferably 25 mN/m or more and more preferably 30 mN/m or more, and preferably 45 mN/m or less and more preferably 40 mN/m or less. Further, in another aspect of the present invention, the above surface tension of component (A2) may be 30 mN/m or more and 50.0 mN/m or less, and further 40 mN/m or less. Further, in still another aspect of the present invention, the above surface tension of component (A2) may be 20.0 mN/m or more and 35 mN/m or less. Further, in still another aspect of the present invention, numerical values selected from 20.0 mN/m, 25 mN/m, 30 mN/m, 35 mN/m, 40 mN/m, 45 mN/m and 50.0 mN/m can be combined and set as an upper limit and a lower limit of the range of the above surface tension of component (A2).

From the viewpoint of reducing surface tension to prevent solidification, examples of component (A2) include one or more selected from polyol fatty acid esters, polyoxyalkylene alkyl ethers, polyoxyalkylene alkyl phenyl ethers, polyoxyethylene polyoxypropylene glycols, fatty acid polyalkylene glycol esters, fatty acid polyoxyalkylene polyols, fatty acid alkanol amides, organopolysiloxanes and others, and one or more selected from polyol fatty acid esters, polyoxyalkylene alkyl ethers, polyoxyalkylene alkyl phenyl ethers, polyoxyethylene polyoxypropylene glycols, fatty acid polyalkylene glycol esters, fatty acid polyoxyalkylene polyols and organopolysiloxanes are preferable, and one or more selected from polyol fatty acid esters, polyoxyalkylene alkyl ethers, polyoxyethylene polyoxypropylene glycols, fatty acid polyalkylene glycol esters, fatty acid polyoxyalkylene polyols and organopolysiloxanes are more preferable.

When component (A2) is one or more selected from fatty acid polyalkylene glycol esters, a fatty acid has preferably 8 or more, more preferably 12 or more and further preferably 16 or more, and preferably 22 or less, more preferably 20 or less and further preferably 18 or less carbons from the viewpoint of the effect of reducing surface tension.

When component (A2) is one or more selected from fatty acid polyalkylene glycol esters, a repeat unit of a polyoxyalkylene is preferably a polyoxyethylene group and/or a polyoxypropylene group from the viewpoint of the effect of reducing surface tension.

When component (A2) is one or more selected from fatty acid polyalkylene glycol esters, a polymerization average number of added moles of a repeat unit of a polyoxyalkylene of a fatty acid polyalkylene glycol ester relative to 1 mol of a fatty acid is preferably 1 or more, more preferably 5 or more and further preferably 10 or more, and preferably 50 or less, more preferably 40 or less and further preferably 30 or less from the viewpoint of the effect of reducing surface tension.

When component (A2) is one or more selected from polyoxyalkylene alkyl ethers, and a repeat unit of a polyoxyalkylene includes a polyoxyethylene group, a polymerization average number of added moles of a repeat unit of a polyoxyethylene group relative to 1 mol of an alkyl group is preferably 1 or more, more preferably 5 or more and further preferably 10 or more, and preferably 45 or less, more preferably 35 or less and further preferably 25 or less from the viewpoint of the effect of reducing surface tension.

When component (A2) is one or more selected from polyoxyalkylene alkyl ethers, and a repeat unit of a polyoxyalkylene includes a polyoxypropylene group, a polymerization average number of added moles of a repeat unit of a polyoxypropylene group relative to 1 mol of an alkyl group is preferably 1 or more, more preferably 3 or more and further preferably 5 or more, and preferably 30 or less, more preferably 20 or less and further preferably 10 or less from the viewpoint of the effect of reducing surface tension.

When component (A2) is one or more selected from organopolysiloxanes, an organopolysiloxane is preferably dimethylsiloxane and/or a modified product thereof and more preferably a reaction product of dimethylsiloxane/silica from the viewpoint of the effect of reducing surface tension.

From the viewpoint of reducing surface tension to prevent solidification, component (A2) is preferably a fatty acid polyalkylene glycol ester, and preferably a fatty acid polyalkylene glycol ester, wherein a fatty acid has 16 or more and 18 or less carbons, a repeat unit of a polyoxyalkylene is a polyoxypropylene group, and a polymerization average number of added moles of a repeat unit of a polyoxypropylene group relative to 1 mol of a fatty acid is 5 or more and 10 or less.

Component (A2) has an HLB value calculated by Griffin's method of preferably 0 or more, more preferably 0.0 or more, further preferably 0.5 or more and furthermore preferably 1.0 or more, and preferably 6.0 or less, more preferably 5.5 or less and further preferably 5.0 or less from the viewpoint of anti-solidifying properties.

A content of component (A1) in particle (A) is preferably 95 mass % or more and more preferably 98 mass % or more, and preferably 99.9 mass % or less and more preferably 99.5 mass % or less.

Further, a content of component (A2) in particle (A) is preferably 0.1 mass % or more and more preferably 0.5 mass % or more, and preferably 5 mass % or less and more preferably 2 mass % or less.

A part by mass of a content of component (A2) relative to 100 parts by mass of a content of component (A1) in particle (A) is preferably 0.1 parts by mass or more, more preferably 0.3 parts by mass or more, further preferably 0.5 parts by mass or more and furthermore preferably 0.7 parts by mass or more, and preferably 2.0 parts by mass or less, more preferably 1.8 parts by mass or less, further preferably 1.6 parts by mass or less, furthermore preferably 1.5 parts by mass or less, furthermore preferably 1.4 parts by mass or less and furthermore preferably 1.0 parts by mass or less from the viewpoint of cement dispersibility.

A proportion of components (A1) and (A2) in particle (A) is preferably 70 mass % or more and more preferably 80 mass % or more, and preferably 95 mass % or less and more preferably 90 mass& or less.

Particle (A) has a median diameter (D50; μm) of 90 μm or more and 600 μm or less, wherein a proportion of particles with a particle size of 70 μm or less is 15 volume or less. This median diameter (D50) is measured under no ultrasonic irradiation using laser diffraction/scattering particle size distribution measuring instrument LA-300 (manufactured by HORIBA, Ltd.) with ethanol (Ethanol (95), manufactured by FUJIFILM Wako Pure Chemical Corporation) as a dispersion medium. Further, a proportion of particles with a particle size of 70 μm or less is calculated on the basis of a particle size result measured in the same manner as a median diameter.

In one aspect of the present invention, particle (A) has a median diameter (D50; μm) of preferably 90.0 μm or more, more preferably 100 μm or more and further preferably 110 μm or more, and preferably 600.0 μm or less, more preferably 450 μm or less, further preferably 400 μm or less and furthermore preferably 300 μm or less.

Further, in another aspect of the present invention, particle (A) may have a median diameter (D50; μm) of 100 μm or more, and 300 μm or less, further 150 μm or less and further 120 μm or less. Further, in still another aspect of the present invention, particle (A) may have a median diameter (D50; μm) of 150 μm or more and 200 μm or less. Further, in still another aspect of the present invention, particle (A) may have a median diameter (D50; μm) of 250 μm or more and 300 μm or less.

Further, in still another aspect of the present invention, numerical values selected from 90 μm, 90.0 μm or more, 100 μm, 110 μm, 120 μm, 150 μm, 200 μm, 250 μm, 300 μm, 400 μm, 450 μm, 600.0 μm and 600 μm can be combined and set as an upper limit and a lower limit of the range of a median diameter (D50; μm) of particle (A).

Further, in one aspect of the present invention, a proportion of particles with a particle size of 70 μm or less in particle (A) is preferably 12 volume % or less, more preferably 9 volume % or less and further preferably 6 volume % or less. Further, in another aspect of the present invention, a proportion of particles with a particle size of 70 μm or less in particle (A) may be 0.5 volume % or more, further 4 volume % or more and further 5 volume % or more, and 9 volume % or less and further 6 volume % or less. Further, in still another aspect of the present invention, a proportion of particles with a particle size of 70 μm or less in particle (A) may be 0.5 volume % or more and 2 volume % or less. Further, in still another aspect of the present invention, numerical values selected from 0.5 volume %, 2 volume %, 4 volume %, 5 volume %, 6 volume %, 9 volume %, 12 volume % and 15.0 volume % can be combined and set as an upper limit and a lower limit for a proportion of particles with a particle size of 70 μm or less in particle (A).

Particle (A) can be obtained, for example, by drying a mixture containing component (A1), component (A2) and water. The mixture is preferably an aqueous solution. Drying of the mixture, for example, an aqueous solution, can be carried out by heat drying or vacuum drying, and is preferably carried out by heat drying from the viewpoint of productivity of a dried product. Drying of the mixture, for example, an aqueous solution, is preferably carried out by a method such as a thin-film drying method, a spray drying method, an agitation drying method or the like. Examples of a thin-film drying method include a drum drying method, a disc drying method and a belt drying method. Drying of the mixture, for example, an aqueous solution, is preferably carried out by heat drying. Further, drying of the mixture, for example, an aqueous solution, is preferably carried out by a thin-film drying method or a spray drying method. The obtained powder is preferably used as particle (A) as-is or after subjected to sieving or other particle size adjustments.

Particle (B) is particles formed of an inorganic compound and having a median diameter (D50; μm) of 1 μm or more and 50 μm or less. This median diameter (D50) is measured under no ultrasonic irradiation using laser diffraction/scattering particle size distribution measuring instrument LA-300 (manufactured by HORIBA, Ltd.) with ethanol (Ethanol (95), manufactured by FUJIFILM Wako Pure Chemical Corporation) as a dispersion medium.

Particle (B) has a median diameter (D50; μm) of preferably 1.0 μm or more, more preferably 5 μm or more and further preferably 10 μm or more, and preferably 50.0 μm or less, more preferably 40 μm or less and more preferably 20 μm or less.

Examples of an inorganic compound of particle (B) include powders of inorganic salts such as calcium carbonate, calcium silicate or the like, clay mineral powders such as kaolinite, bentonite or the like or fine powders such as blast furnace slag, fly ash or the like, lithium carbonate, potassium sulfate, sodium sulfate, aluminum sulfate, builders, zeolite, calcium hydroxide, magnesium hydroxide, aluminum hydroxide, silica powder (for example, silica fine powder, porous silica fine powder or the like) or a combination of any of them or the like. Among these, silica powder (for example, silica fine powder, porous silica fine powder or the like) or powders of inorganic salts such as calcium carbonate, calcium silicate or the like are preferable from the viewpoint of anti-solidifying properties. In other words, particle (B) is preferably particles selected from silica powder, calcium carbonate powder and calcium silicate powder.

Particle (B) is preferably particles formed of an inorganic compound and not exhibiting hydraulic properties and having a median diameter (D50; μm) of 1 μm or more and 50 μm or less.

Note that, in the context of particle (B), not exhibiting hydraulic properties means that particle (B) does not cause hardening by a chemical reaction with water, in other words, it does not harden chemically in the presence of water.

An aqueous solution or aqueous suspension of the powder dispersant composition for hydraulic compositions of the present invention at a concentration of 5 mass % has a surface tension of 20.0 mN/m or more and 50.0 mN/m or less at 25° C. The above surface tension of the composition is measured by a du Noüy tensiometer described in JIS K-3362. In one aspect of the present invention, the above surface tension of the composition is preferably 30 mN/m or more, more preferably 35 mN/m or more and further preferably 40 mN/m or more, and preferably 48 mN/m or less and more preferably 46 mN/m or less. Further, in another aspect of the present invention, the above surface tension of the composition may be 35 mN/m or more and 50.0 mN/m or less. Further, in still another aspect of the present invention, the above surface tension of the composition may be 30 mN/m or more and 40 mN/m or less. Further, in still another aspect of the present invention, numerical values selected from 20.0 mN/m, 30 mN/m, 35 mN/m, 40 mN/m, 46 mN/m, 48 mN/m and 50.0 mN/m can be combined and set as an upper limit and a lower limit of the range of the above surface tension of the composition.

The powder dispersant composition for hydraulic compositions of the present invention preferably contains particles (A) and (B) such that the composition has a surface tension falling within the above predetermined range.

A content of particle (A) in the powder dispersant composition for hydraulic compositions of the present invention is preferably 50 mass % or more and more preferably 70 mass % or more, and preferably 95 mass % or less and more preferably 90 mass % or less.

A content of particle (B) in the powder dispersant composition for hydraulic compositions of the present invention is preferably 0.5 mass % or more, more preferably 0.8 mass % or more, further preferably 1 mass % or more and furthermore preferably 5 mass % or more, and preferably 20 mass % or less and more preferably 10 mass % or less.

The powder dispersant composition for hydraulic compositions of the present invention contains particle (B) in an amount of preferably 0.1 parts by mass or more, more preferably 1 part by mass or more, further preferably 3 parts by mass or more and furthermore preferably 5 parts by mass or more, and preferably 15 parts by mass or less, more preferably 12 parts by mass or less, further preferably 10 parts by mass or less and further 9 parts by mass or less relative to 100 parts by mass of component (A1) in particle (A) from the viewpoint of anti-solidifying properties at high temperatures.

The powder dispersant composition for hydraulic compositions of the present invention can contain optional components other than particles (A) and (B). Examples of such optional components include powder defoamers, powder shrinkage reducing agents, powder thickening agents or the like, provided that those not qualifying for particles (A) and (B) are selected for them. Examples of powder defoamers and powder shrinkage reducing agents include polyoxyalkylene glycol alkyl ethers. Examples of powder thickening agents include cellulose derivatives such as hydroxypropyl methylcellulose, hydroxyethyl cellulose, carboxymethyl cellulose, methyl cellulose or the like. Further, the composition can contain organic powders such as polyethylene glycol or the like as powdering aids.

The powder dispersant composition for hydraulic compositions of the present invention may be a powder dispersant composition for hydraulic compositions formulated with particles (A) and (B), wherein an aqueous solution or aqueous suspension of the powder dispersant composition for hydraulic compositions at a concentration of 5 mass % has a surface tension of 20.0 mN/m or more and 50.0 mN/m or less at 25° C.

According to the present invention, provided is a method for producing the powder dispersant composition for hydraulic compositions of the present invention including, drying a mixture containing component (A1), component (A2) and water to produce particle (A), and mixing particle (A) with particle (B). The matters stated in the powder dispersant composition for hydraulic compositions of the present invention can be appropriately applied to the method for producing the powder dispersant composition for hydraulic compositions of the present invention. The specific examples, preferable aspects or the like of particles (A) and (B) and components (A1) and (A2) in the method for producing the powder dispersant composition for hydraulic compositions of the present invention are also the same as those in the powder dispersant composition for hydraulic compositions of the present invention. Drying of the mixture can be carried out by any method stated for particle (A) in the powder dispersant composition for hydraulic compositions of the present invention.

Further, according to the present invention, use of the composition of the present invention as a powder dispersant for hydraulic compositions is provided. In other words, provided is use as a powder dispersant for hydraulic compositions of a composition containing particles (A) and (B), wherein an aqueous solution or aqueous suspension of the composition at a concentration of 5 mass % has a surface tension of 20.0 mN/m or more and 50.0 mN/m or less at 25° C. The matters stated in the powder dispersant composition for hydraulic compositions of the present invention can be appropriately applied to the use of the present invention. The specific examples, preferable aspects or the like of particles (A) and (B) and components (A1) and (A2) in the use of the present invention are also the same as those in the powder dispersant composition for hydraulic compositions of the present invention.

### [Premix for Hydraulic Compositions]

The premix for hydraulic compositions of the present invention is a premix for hydraulic compositions formulated with the powder dispersant composition for hydraulic compositions of the present invention, (C) one or more hydraulic powders selected from cement, gypsum, slag, fly ash and lime [hereinafter referred to as component (C)] and (D) a fine aggregate [hereinafter referred to as component (D)].

The matters stated in the powder dispersant composition for hydraulic compositions of the present invention can be appropriately applied to the premix for hydraulic compositions of the present invention. The specific examples, preferable aspects or the like of particles (A) and (B) and components (A1) and (A2) in the premix for hydraulic compositions of the present invention are also the same as those in the powder dispersant composition for hydraulic compositions of the present invention.

The premix for hydraulic compositions of the present invention is a mixture for producing hydraulic compositions such as concrete, mortar or the like, and obtained by mixing in advance the powder dispersant composition for hydraulic compositions of the present invention, component (C) and component (D). Normally, the premix for hydraulic compositions of the present invention is mixed with water and used. Examples of the premix for hydraulic compositions of the present invention include, for example, a mortar premix.

The premix for hydraulic compositions of the present invention is preferably in powder form. In other words, the premix for hydraulic compositions of the present invention is preferably a powder premix for hydraulic compositions formulated with the powder dispersant composition for hydraulic compositions of the present invention, component (C) and component (D) under predetermined conditions.

A formulation amount of particle (A) in the premix for hydraulic compositions of the present invention is preferably 0.01 parts by mass or more, more preferably 0.05 parts by mass or more and further preferably 0.10 parts by mass or more, and preferably 10 parts by mass or less, more preferably 5 parts by mass or less and further preferably 1 part by mass or less relative to 100 parts by mass of the hydraulic powder of component (C) from the viewpoint of fluidity of hydraulic slurry.

A formulation amount of component (C) in the premix for hydraulic compositions of the present invention is preferably 10 mass % or more, more preferably 20 mass % or more and further preferably 30 mass % or more in all the formulation components from the viewpoint of the strength of a hardened product. Further, a formulation amount of component (C) in the premix is preferably 80 mass % or less, more preferably 70 mass % or less and further preferably 60 mass % or less in all the formulation components.

A formulation amount of component (D) in the premix for hydraulic compositions of the present invention is preferably 10 mass % or more, more preferably 20 mass %, or more and further preferably 30 mass % or more in all the formulation components from the viewpoint of fluidity. Further, a formulation amount of component (D) in the premix is preferably 80 mass % or less, more preferably 70 mass % or less and further preferably 60 mass % or less in all the formulation components.

The hydraulic composition of the present invention is preferably a premix for hydraulic slurry.

A hydraulic powder of component (C) refers to a powder having physical properties for hardening through a hydration reaction, and examples include cement, gypsum or the like. It is preferably cement such as ordinary Portland cement, belite cement, moderate heat cement, rapid hardening cement, extra rapid hardening cement, sulfate resisting cement or the like. Further, cement such as blast furnace slag cement, fly ash cement, silica fume cement or the like obtained by adding a powder having pozzolanic reactivity and/or latent hydraulic properties such as blast furnace slag, fly ash, silica fume or the like, stone dust (calcium carbonate powder), or the like to cement can also be used. In the present invention, when a hydraulic powder includes, in addition to a powder having physical properties for hardening through a hydration reaction such as cement or the like, a powder selected from a powder having pozzolanic reactivity, a powder having latent hydraulic properties and stone dust (calcium carbonate powder), the amount thereof is also included in the amount of the hydraulic powder. Further, when a powder having physical properties for hardening through a hydraulic reaction contains a high strength admixture, the amount of the high strength admixture is also included in the amount of the hydraulic powder. The same applies to parts by mass, mass ratios or the like relating to the mass of a hydraulic powder.

Examples of a fine aggregate of component (D) include those prescribed in No. 2311 in JIS A 0203-2014. Examples of fine aggregates include river sand, land sand, pit sand, sea sand, lime sand, silica sand and crushed sands thereof, blast furnace slag fine aggregate, ferronickel slag fine aggregate, lightweight fine aggregate (artificial and natural) and recycled fine aggregate, and the like. A mixture of different types of fine aggregates or a single type thereof may be used.

The composition of the premix for hydraulic compositions of the present invention can be appropriately set according to the hydraulic composition to be prepared by using this.

The premix for hydraulic compositions of the present invention can contain optional components such as powder defoamers, powder shrinkage reducing agents, powder expansive agents, powder hardening accelerators, powder hardening retardants, powder foaming agents, powder waterproofing admixtures, powder corrosion inhibitors or the like.

While the powder dispersant composition for hydraulic compositions of the present invention itself is excellent in thermostability, such as being less likely to solidify even under high temperature environments, or the like, a hydraulic powder also becomes less likely to solidify even under high temperature environments if the hydraulic powder is formulated with this. In other words, the powder dispersant composition for hydraulic compositions of the present invention can be used, for example, as an anti-solidifying agent for hydraulic powder. The present invention provides use as an anti-solidifying agent for hydraulic powder of a composition containing particles (A) and (B), wherein an aqueous solution or aqueous suspension of the composition at a concentration of 5 mass % has a surface tension of 20.0 mN/m or more and 50.0 mN/m or less at 25° C. Particles (A) and (B) are the same as those stated in the powder dispersant composition for hydraulic compositions of the present invention. The matters stated in the powder dispersant composition for hydraulic compositions of the present invention can be appropriately applied to the use of the present invention.

### [Hydraulic Composition]

The hydraulic composition of the present invention is a hydraulic composition formulated with the premix for hydraulic compositions of the present invention and water.

The matters stated in the powder dispersant composition for hydraulic compositions and the premix for hydraulic compositions of the present invention can be appropriately applied to the hydraulic composition of the present invention.

The composition of the hydraulic composition of the present invention, for example, water/hydraulic powder ratio or the like, can be appropriately set according to its purpose or the like.

The hydraulic composition of the present invention can be used for smoothing of floor surfaces, wall surfaces or the like, filling of molds, cavities or the like, defect repairs, extrusion molding, spraying, pile wall protection, seepage prevention or the like.

The hydraulic composition of the present invention has a water/hydraulic powder ratio (hereinafter sometimes also referred to as W/P) of preferably 10 mass % or more, more preferably 20 mass % or more and further preferably 30 mass % or more, and preferably 200 mass % or less, more preferably 100 mass % or less, further preferably 50 mass % or less and furthermore preferably 40 mass % or less from the viewpoint of strength.

Here, water/hydraulic powder ratio represents a mass percentage (mass %) of water to a hydraulic powder in a hydraulic composition, and is calculated by water/hydraulic powder×100. Water/hydraulic powder ratio is calculated on the basis of the amount of a powder having physical properties for hardening through a hydration reaction. When a powder having physical properties for hardening through a hydration reaction contains a high strength admixture, the amount of the high strength admixture is also included in the amount of the hydraulic powder. The same applies to the other quantitative relationships relating to a hydraulic powder in the hydraulic composition.

The hydraulic composition of the present invention can contain optional components such as conventional cement dispersants, water-soluble polymeric compounds, air-entraining agents, cement wetting agents, expansive admixtures, waterproofing agents, retardants, quick setting agents, foaming agents, blowing agents, waterproofing agents, fluidizing agents, thickening agents, flocculating agents, drying shrinkage reducing agents, strength enhancing agents, hardening accelerators, antiseptics, defoamers or the like.

The present invention provides a method for producing a hydraulic slurry including, mixing the powder dispersant composition for hydraulic compositions of the present invention, component (C), component (D) and water.

Further, the present invention provides a method for producing a hydraulic slurry including, mixing the premix for hydraulic compositions of the present invention and water.

Further, the present invention provides a method for producing a hardened product including, filling a mold with the hydraulic slurry produced by any of the above methods to harden the slurry.

A formulation amount of particle (A) in the hydraulic composition is preferably 0.01 mass % or more, more preferably 0.03 mass % or more and further preferably 0.05 mass % or more in all the formulation components from the viewpoint of cement dispersibility. Further, a formulation amount of particle (A) in the hydraulic composition is preferably 2 mass % or less, more preferably 1 mass % or less and further preferably 0.5 mass % or less in all the formulation components from the viewpoint of cement dispersibility.

A formulation amount of particle (B) in the hydraulic composition is preferably 0.0001 mass % or more, more preferably 0.0003 mass % or more and further preferably 0.0005 mass % or more in all the formulation components from the viewpoint of anti-solidifying properties at high temperatures. Further, a formulation amount of particle (B) in the hydraulic composition is preferably 0.05 mass % or less, more preferably 0.03 mass % or less and further preferably 0.01 mass % or less in all the formulation components from the viewpoint of anti-solidifying properties at high temperatures.

A formulation amount of component (C) in the hydraulic composition is preferably 10 mass % or more, more preferably 20 mass % or more and further preferably 30 mass % or more in all the formulation components from the viewpoint of the strength of a hardened product. Further, a formulation amount of particle (C) in the hydraulic composition is preferably 80 mass % or less, more preferably 70 mass % or less and further preferably 60 mass % or less in all the formulation components from the viewpoint of the strength of a hardened product.

A formulation amount of component (D) in the hydraulic composition is preferably 10 mass % or more, more preferably 20 mass % or more and further preferably 30 mass % or more in all the formulation components from the viewpoint of fluidity. Further, a formulation amount of particle (D) in the hydraulic composition is preferably 80 mass % or less, more preferably 70 mass % or less and further preferably 60 mass % or less in all the formulation components from the viewpoint of fluidity.

In addition to the above embodiments, the present invention discloses the aspects below. The matters stated in the powder dispersant composition for hydraulic compositions, the premix for hydraulic compositions, the hydraulic composition, the method for producing the powder dispersant composition for hydraulic compositions and the use of the present invention can be appropriately incorporated into the aspects below.

<1> A powder dispersant composition for hydraulic compositions containing the following particles (A) and (B), wherein an aqueous solution or aqueous suspension of the powder dispersant composition for hydraulic compositions at a concentration of 5 mass % has a surface tension of 20.0 mN/m or more and 50.0 mN/m or less at 25° C.,

### <Particle (A)>

particles containing the following components (A1) and (A2) and having a median diameter (D50; μm) of 90.0 μm or more and 600.0 μm or less, wherein a proportion of particles with a particle size of 70 μm or less is 15.0 volume % or less,

### [Component (A1)]

a copolymer including constituent unit (1) represented by the following formula (1) and constituent unit (2) represented by the following formula (2), wherein all the raw material monomers of the copolymer have a melting point of −80° C. or more and 80° C. or less,

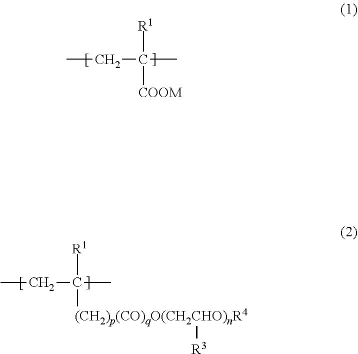

wherein R¹ and R³ are the same or different and each represent a hydrogen atom or a methyl group, R² and R⁴ are the same or different and each represent a hydrogen atom or an alkyl group with 1 or more and 3 or less carbons, M represents a hydrogen atom, an alkali metal, an alkaline earth metal, ammonium or an organic ammonium, p represents a number of 0 or more and 2 or less, q represents a number of 0 or 1, and n represents an average number of added moles and represents a number of 5 or more and 150 or less, and

### [Component (A2)]

a nonionic surfactant whose aqueous solution or aqueous suspension at a concentration of 5 mass % has a surface tension of 20.0 mN/m or more and 50.0 mN/m or less at 25° C., and

### <Particle (B)>

particles formed of an inorganic compound and having a median diameter (D50; μm) of 1.0 μm or more and 50.0 μm or less.
   <2>

A powder dispersant composition for hydraulic compositions containing the following particles (A) and (B), wherein an aqueous solution or aqueous suspension of the powder dispersant composition for hydraulic compositions at a concentration of 5 mass % has a surface tension of 20.0 mN/m or more and 50.0 mN/m or less at 25° C.,

### <Particle (A)>

particles containing the following components (A1) and (A2) and having a median diameter (D50; μm) of 90 μm or more and 600 μm or less, wherein a proportion of particles with a particle size of 70 μm or less is 15 volume % or less,

### [Component (A1)]

a copolymer including constituent unit (1) represented by the following formula (1) and constituent unit (2) represented by the following formula (2), wherein all the raw material monomers of the copolymer have a melting point of −80° C. or more and 80° C. or less,

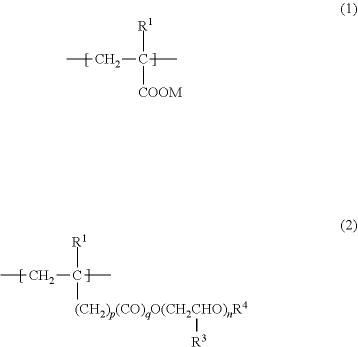

wherein R¹ and R³ are the same or different and each represent a hydrogen atom or a methyl group, R² and R⁴ are the same or different and each represent a hydrogen atom or an alkyl group with 1 or more and 3 or less carbons, M represents a hydrogen atom, an alkali metal, an alkaline earth metal, ammonium or an organic ammonium, p represents a number of 0 or more and 2 or less, q represents a number of 0 or 1, and n represents an average number of added moles and represents a number of 5 or more and 150 or less, and
   [component (A2)]
a nonionic surfactant whose aqueous solution or aqueous suspension at a concentration of 5 mass % has a surface tension of 20.0 mN/m or more and 50.0 mN/m or less at 25° C., and
   <particle (B)>
particles formed of an inorganic compound and having a median diameter (D50; μm) of 1 μm or more and 50 μm or less.
   <3>

The powder dispersant composition for hydraulic compositions according to <1> or <2>, wherein the composition contains particle (B) in an amount of 0.1 parts by mass or more and 15 parts by mass or less relative to 100 parts by mass of component (A1) in particle (A).

<4>

The powder dispersant composition for hydraulic compositions according to any one of <1> to <3>, wherein a part by mass of a content of component (A2) relative to 100 parts by mass of a content of component (A1) in particle (A) is 0.1 parts by mass or more and 2.0 parts by mass or less.

<5>

A powder dispersant composition for hydraulic compositions containing the following particles (A) and (B),
wherein the composition contains particle (B) in an amount of 3 parts by mass or more and 10 parts by mass or less relative to 100 parts by mass of component (A1) in particle (A),
a part by mass of a content of component (A2) relative to 100 parts by mass of a content of component (A1) in particle (A) is 0.1 parts by mass or more and 2.0 parts by mass or less, and
an aqueous solution or aqueous suspension of the powder dispersant composition for hydraulic compositions at a concentration of 5 mass % has a surface tension of 35 mN/m or more and 50.0 mN/m or less at 25° C.,

### <Particle (A)>

particles containing the following components (A1) and (A2) and having a median diameter (D50; μm) of 100 μm or more and 300 μm or less, wherein a proportion of particles with a particle size of 70 μm or less is 0.5 volume % or more and 9 volume? or less,

### [Component (A1)]

a copolymer including constituent unit (1) represented by the following formula (1) and constituent unit (2) represented by the following formula (2), wherein all the raw material monomers of the copolymer have a melting point of −80° C. or more and 70° C. or less, a monomer to be constituent unit (1) has a melting point of 5° C. or more and 20° C. or less, and a monomer to be constituent unit (2) has a melting point of 50° C. or more and 65° C. or less,

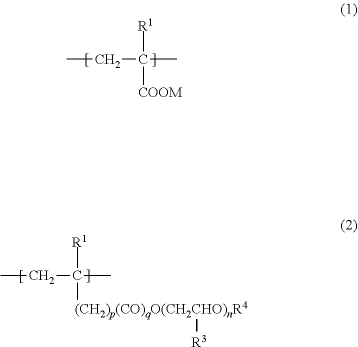

wherein R¹ and R³ are the same or different and each represent a hydrogen atom or a methyl group, R² and R⁴ are the same or different and each represent a hydrogen atom or an alkyl group with 1 or more and 3 or less carbons, M represents a hydrogen atom, an alkali metal, an alkaline earth metal, ammonium or an organic number 1, and n represents an average number of added moles and represents a number of 40 or more and 130 or less, and

### [Component (A2)]

a nonionic surfactant whose aqueous solution or aqueous suspension at a concentration of 5 mass % has a surface tension of 30 mN/m or more and 50.0 mN/m or less at 25° C., and

### <Particle (B)>

particles formed of an inorganic compound and having a median diameter (D50; μm) of 10 μm or more and 40 μm or less.
   <6>

The powder dispersant composition for hydraulic compositions according to any one of <1> to <5>, wherein component (A1) optionally includes constituent unit (3) represented by the following formula (3), and wherein a proportion of constituent unit (1) is 45 mol % or more and 95 mol % or less, a proportion of constituent unit (2) is 5 mol % or more and 30 mol % or less, and a proportion of constituent unit (3) is 0 mol % or more and 35 mol % or less in a total of contents of constituent units (1) to (3),

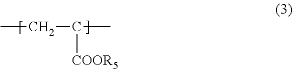

wherein R⁵ represents a hydrocarbon group with 1 or more and 4 or less carbons which may include hetero atoms.
   <7>

A powder dispersant composition for hydraulic compositions containing the following particles (A) and (B),
wherein the composition contains particle (B) in an amount of 5 parts by mass or more and 10 parts by mass or less relative to 100 parts by mass of component (A1) in particle (A),
a part by mass of a content of component (A2) relative to 100 parts by mass of a content of component (A1) in particle (A) is 0.5 parts by mass or more and 1.0 parts by mass or less, and
an aqueous solution or aqueous suspension of the powder dispersant composition for hydraulic compositions at a concentration of 5 mass % has a surface tension of 35 mN/m or more and 50.0 mN/m or less at 25° C.,

### <Particle (A)>

particles containing the following components (A1) and (A2) and having a median diameter (D50; μm) of 100 μm or more and 120 μm or less, wherein a proportion of particles with a particle size of 70 μm or less is 4 volume? or more and 6 volume % or less,

### [Component (A1)]

a copolymer including constituent unit (1) represented by the following formula (1) and constituent unit (2) represented by the following formula (2), wherein all the raw material monomers of the copolymer have a melting point of −80° C. or more and 70° C. or less, a monomer to be constituent unit (1) has a melting point of 10° C. or more and 20° C. or less, and a monomer to be constituent unit (2) has a melting point of 50° C. or more and 65° C. or less,

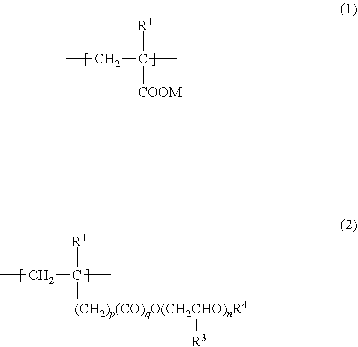

wherein R¹ and R³ are the same or different and each represent a hydrogen atom or a methyl group, R² and R⁴ are the same or different and each represent a hydrogen atom or an alkyl group with 1 or more and 3 or less carbons, M represents a hydrogen atom, an alkali metal, an alkaline earth metal, ammonium or an organic ammonium, p represents the number 0, q represents the number 1, and n represents an average number of added moles and represents a number of 100 or more and 150 or less, and

### [Component (A2)]

a nonionic surfactant whose aqueous solution or aqueous suspension at a concentration of 5 masse has a surface tension of 30 mN/m or more and 40 mN/m or less at 25° C., and

### <Particle (B)>

particles formed of an inorganic compound and having a median diameter (D50; μm) of 10 μm or more and 20 μm or less.
   <8>

A powder dispersant composition for hydraulic compositions containing the following particles (A) and (B),
wherein the composition contains particle (B) in an amount of 5 parts by mass or more and 10 parts by mass or less relative to 100 parts by mass of component (A1) in particle (A),
a part by mass of a content of component (A2) relative to 100 parts by mass of a content of component (A1) in particle (A) is 0.5 parts by mass or more and 1.0 parts by mass or less, and
an aqueous solution or aqueous suspension of the powder dispersant composition for hydraulic compositions at a concentration of 5 mass % has a surface tension of 35 mN/m or more and 50.0 mN/m or less at 25° C.,

### <Particle (A)>

particles containing the following components (A1) and (A2) and having a median diameter (D50; μm) of 150 μm or more and 200 μm or less, wherein a proportion of particles with a particle size of 70 μm or less is 0.5 volume % or more and 2 volume % or less,

### [Component (A1)]

a copolymer including constituent unit (1) represented by the following formula (1) and constituent unit (2) represented by the following formula (2), wherein all the raw material monomers of the copolymer have a melting point of −80° C. or more and 70° C. or less, a monomer to be constituent unit (1) has a melting point of 10° C. or more and 20° C. or less, and a monomer to be constituent unit (2) has a melting point of 50° C. or more and 65° C. or less,

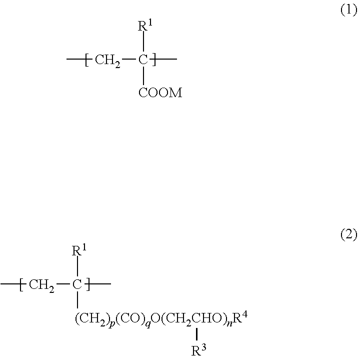

wherein R¹ and R³ are the same or different and each represent a hydrogen atom or a methyl group, R² and R⁴ are the same or different and each represent a hydrogen atom or an alkyl group with 1 or more and 3 or less carbons, M represents a hydrogen atom, an alkali metal, an alkaline earth metal, ammonium or an organic ammonium, p represents the number 0, q represents the number 1, and n represents an average number of added moles and represents a number of 100 or more and 150 or less, and

### [Component (A2)]

a nonionic surfactant whose aqueous solution or aqueous suspension at a concentration of 5 mass % has a surface tension of 30 mN/m or more and 40 mN/m or less at 25° C., and

### <Particle (B)>

particles formed of an inorganic compound and having a median diameter (D50; μm) of 10 μm or more and 20 μm or less.
   <9>

A powder dispersant composition for hydraulic compositions containing the following particles (A) and (B),
wherein the composition contains particle (B) in an amount of 5 parts by mass or more and 10 parts by mass or less relative to 100 parts by mass of component (A1) in particle (A),
a part by mass of a content of component (A2) relative to 100 parts by mass of a content of component (A1) in particle (A) is 0.5 parts by mass or more and 1.0 parts by mass or less, and
an aqueous solution or aqueous suspension of the powder dispersant composition for hydraulic compositions at a concentration of 5 mass % has a surface tension of 35 mN/m or more and 50.0 mN/m or less at 25° C.,

### <Particle (A)>

particles containing the following components (A1) and (A2) and having a median diameter (D50; μm) of 250 μm or more and 300 μm or less, wherein a proportion of particles with a particle size of 70 μm or less is 5 volume % or more and 9 volume % or less,

### [Component (A1)]

a copolymer including constituent unit (1) represented by the following formula (1) and constituent unit (2) represented by the following formula (2), wherein all the raw material monomers of the copolymer have a melting point of −80° C. or more and 70° C. or less, a monomer to be constituent unit (1) has a melting point of 10° C. or more and 20° C. or less, and a monomer to be constituent unit (2) has a melting point of 50° C. or more and 65° C. or less,

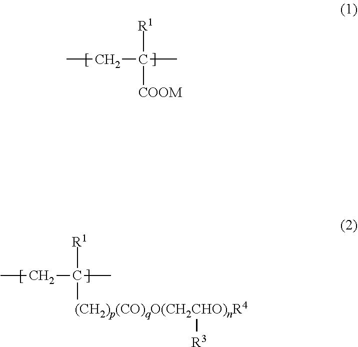

wherein R¹ and R³ are the same or different and each represent a hydrogen atom or a methyl group, R² and R⁴ are the same or different and each represent a hydrogen atom or an alkyl group with 1 or more and 3 or less carbons, M represents a hydrogen atom, an alkali metal, an alkaline earth metal, ammonium or an organic number 1, and n represents an average number of added moles and represents a number of 100 or more and 150 or less, and

### [Component (A2)]

a nonionic surfactant whose aqueous solution or aqueous suspension at a concentration of 5 mass % has a surface tension of 30 mN/m or more and 40 mN/m or less at 25° C., and

### <Particle (B)>

particles formed of an inorganic compound and having a median diameter (D50; μm) of 10 μm or more and 20 μm or less.
   <10>

A powder dispersant composition for hydraulic compositions containing the following particles (A) and (B),
wherein the composition contains particle (B) in an amount of 5 parts by mass or more and 10 parts by mass or less relative to 100 parts by mass of component (A1) in particle (A),
a part by mass of a content of component (A2) relative to 100 parts by mass of a content of component (A1) in particle (A) is 0.5 parts by mass or more and 1.0 parts by mass or less, and
an aqueous solution or aqueous suspension of the powder dispersant composition for hydraulic compositions at a concentration of 5 mass % has a surface tension of 30 mN/m or more and 40 mN/m or less at 25° C.,

### <Particle (A)>

particles containing the following components (A1) and (A2) and having a median diameter (D50; μm) of 100 μm or more and 150 μm or less, wherein a proportion of particles with a particle size of 70 μm or less is 4 volume % or more and 9 volume % or less,

### [Component (A1)]

a copolymer including constituent unit (1) represented by the following formula (1) and constituent unit (2) represented by the following formula (2), wherein all the raw material monomers of the copolymer have a melting point of −80° C. or more and 70° C. or less, a monomer to be constituent unit (1) has a melting point of 10° C. or more and 20° C. or less, and a monomer to be constituent unit (2) has a melting point of 50° C. or more and 65° C. or less,

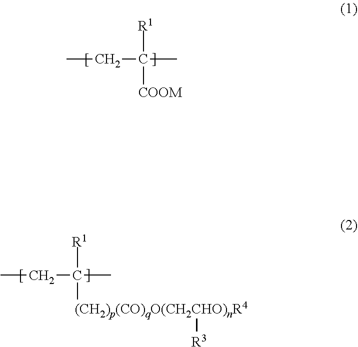

wherein R¹ and R³ are the same or different and each represent a hydrogen atom or a methyl group, R² and R⁴ are the same or different and each represent a hydrogen atom or an alkyl group with 1 or more and 3 or less carbons, M represents a hydrogen atom, an alkali metal, an alkaline earth metal, ammonium or an organic ammonium, p represents the number 0, q represents the number 1, and n represents an average number of added moles and represents a number of 100 or more and 150 or less, and

### [Component (A2)]

a nonionic surfactant whose aqueous solution or aqueous suspension at a concentration of 5 mass % has a surface tension of 20.0 mN/m or more and 35 mN/m or less at 25° C., and

### <Particle (B)>

particles formed of an inorganic compound and having a median diameter (D50; μm) of 10 μm or more and 20 μm or less.
   <11>

The powder dispersant composition for hydraulic compositions according to any one of <7> to <10>, wherein a proportion of a total of constituent units (1) and (2) in all the constituent units of the copolymer of component (A1) is preferably 80 mol % or more and more preferably 90 mol % or more, and preferably 100 mol % or less, or 100 mol %.

<12>

A method for producing the powder dispersant composition for hydraulic compositions according to any one of <1> to <11> including, drying a mixture containing component (A1), component (A2) and water to produce particle (A), and mixing particle (A) with particle (B).

<13>

Use of the composition according to any one of <1> to <11> as a powder dispersant for hydraulic compositions.

### EXAMPLES

### Example 1 and Comparative Example 1

### (1) Material Used

### (1-1) Particle (A)

### Component (A1)

Copolymer 1: methacrylic acid/methoxy polyethylene glycol (120) monomethacrylate=90 mol/10 mol (shown in parenthesis is an average number of added moles, the same applies hereinafter) sodium salt, weight average molecular weight=40,000
Copolymer 2: acrylic acid/methacrylic acid/methoxy polyethylene glycol (50) monomethacrylate=50 mol/30 mol/20 mol (shown in parenthesis is an average number of added moles, the same applies hereinafter) sodium salt, weight average molecular weight=50,000
Copolymer 3=methacrylic acid/methyl acrylate/methoxy polyethylene glycol (50) monomethacrylate/acrylic acid=40 mol/32 mol/20 mol/8 mol (shown in parenthesis is an average number of added moles, the same applies hereinafter) sodium salt, weight average molecular weight=60,000
Comparative copolymer 1: copolymer 1 in Table 1 of WO-A 2006/059723

### Component (A2)

Nonionic surfactant 1: DEFOAMER NO. 21 (polyoxyalkylene derivative mixture, manufactured by Kao Corporation)
Nonionic surfactant 2: DOWSIL DK Q1-1183 Antifoam (reaction product of dimethyl siloxane/silica, manufactured by Dow Toray Co., Ltd.)
   Comparative component for component (A2)
Comparative nonionic surfactant 1: polyoxyethylene (average number of added moles 10) monomethyl ether (manufactured by Kao Corporation)

### (1-2) Particle (B)

Inorganic powder 1: Nipsil NS-K (manufactured by Tosoh Silica Corporation), particles not exhibiting hydraulic properties
Inorganic powder 2: Nipsil VN3 (manufactured by Tosoh Silica Corporation), particles not exhibiting hydraulic properties
   Comparative component for particle (B)
Comparative inorganic powder 1: Nipsil ER-R (manufactured by Tosoh Silica Corporation), particles not exhibiting hydraulic properties

### (2) Production of Powder Dispersant Composition for Hydraulic Compositions

### (2-1) Production Example 1

Some particles (A) were produced by a spray drying method.

Component (A1), component (A2) (or comparative nonionic surfactant 1) and water were added to prepare a mixture for particle (A).

The mixture was spray-dried by practical powdering equipment, thereby producing particle (A). The powdering equipment used was provided with a disc atomizer, air blowing equipment and a dryer, wherein the inlet and outlet temperatures of the dryer were 150° C. and 90° C., respectively, the outdoor air temperature was 20° C., and the number of revolutions of the disc atomizer was 11,000 rpm. After that, particle (A) was put through a sieve with 1 mm mesh for removing coarse particles or foreign materials, and those passing therethrough were used for particle size distribution measurements.

Particle (B) was added and dry-mixed with the obtained particle (A) at parts by mass shown in Table 1 to produce a powder dispersant composition for hydraulic compositions.

### (2-1) Production Example 2

Some particles (A) were produced by a drum drying method.

A mixture prepared in the same manner as in production example 1 was formed into a sheet shape by practical drum drying equipment. Powdering equipment used was provided with a drying drum and a scraper, wherein the area, the number of revolutions and the temperature of the drying drum were 6.2 m², 3.1 rpm and 130° C., respectively, and the outdoor air temperature was 30° C. The obtained sheet was then cooled by practical drum cooling equipment and ground by the Feather Mill. The cooling equipment was installed near the powdering equipment such that sample sheets scraped by the scraper from the drum drying equipment were conveyed subsequently to the cooling equipment. The cooling equipment used was provided with a cooling drum, wherein the area, the number of revolutions and the temperature of the cooling drum were 5.8 m², 1.5 rpm and 20° C., respectively, and the outdoor air temperature was 30° C. After that, particle (A) was put through a sieve with 1 mm mesh for removing coarse particles or foreign materials, and those passing therethrough were used for particle size distribution measurements.

Particle (B) was added and dry-mixed with the obtained particle (A) at parts by mass shown in Table 1 to produce a powder dispersant composition for hydraulic compositions.

### (3) Median Diameter and Particle Size Distribution of Particle (A)

For particle (A) produced in the aforementioned manner, particle size distribution measurements were carried out using laser diffraction/scattering particle size distribution measuring instrument LA-300 (manufactured by HORIBA, Ltd.) and using Ethanol (95) (manufactured by FUJIFILM Wako Pure Chemical Corporation) as a dispersion medium to measure and calculate a median diameter (D50; μm) and a proportion of particles with a particle size of 70 μm or less (volume %). In some examples and comparative examples, particle size distribution measurements were carried out in the same manner for particle (A) whose median diameter (D50; μm) and proportion of particles with a particle size of 70 μm or less (volume %) were adjusted by appropriately mixing those classified by sieves with 75 μm, 100 μm, 150 μm and 250 μm meshes.

### (4) Median Diameter and Particle Size Distribution of Particle (B)

A median diameter of particle (B) was measured in the same manner as a median diameter of particle (A).

### (5) Test

### (5-1) Caking Test

10 g of each powder dispersant composition for hydraulic compositions was developed on an aluminum plate, and placed in a hot air dryer at 110° C. The temperature was then raised to 120° C. and further 130° C., the powder dispersant composition for hydraulic compositions was left to stand at each temperature for 30 minutes with each temperature kept for 30 minutes, and was put through a sieve with 1 mm mesh, and its 1 mm mesh sieve passage rate (%) was calculated on the basis of the formula below as an indicator of anti-solidifying properties. The results are shown in Table 2.

<Method for calculating 1 mm mesh sieve passage rate (?)>
1 mm mesh sieve passage rate (%)=mass of sample passing through 1 mm mesh sieve×100/total mass of sample used for sieving test

### (5-2) Mortar Test

Mortar was prepared according to the mortar formulation below. The formulation components were kneaded (60 rpm, 240 seconds) using a mortar mixer prescribed in JIS R 5201 to prepare the mortar. In that process, addition of each powder dispersant composition for hydraulic compositions shown in Table 1 was carried out by dry-mixing it in advance with the cement and the fine aggregate such that the amount thereof was 0.30 parts by mass relative to 100 parts by mass of the cement. Addition of the nonionic surfactant was carried out by mixing it in advance to tap water.

### <Formulation of Mortar>

Cement: 700 g (rapid hardening Portland cement manufactured by TAIHEIYO CEMENT CORPORATION, specific gravity 3.16)
Fine aggregate: 700 g (sand, from Joyo, Kyoto, specific gravity in saturated surface-dry condition 2.50 g/cm³)
Tap water: 161 g
Nonionic surfactant: 0.05 g (DEFOAMER No. 21, manufactured by Kao Corporation)
W/C: 23

A flow cone (upper diameter 70 mm×lower diameter 100 mm×height 60 mm) described in JIS R 5201 was filled with the above prepared mortar immediately after kneading to measure a mortar flow. The results are shown in Table 2.

TABLE 1

| | | Powder dispersant composition for hydraulic compositions | | | | | | | | | | | | | |
|---|---|---|---|---|---|---|---|---|---|---|---|---|---|---|---|
| | | Particle (A) | | | | | | | | | | | | | |
| | | | | | | | | | | Proportion of | | | | | |
| | | Component (A.1) | | | | Component (A2) | | | | particles with | | Particle (B) | | | |
| | | | Melting point of | | | | | Added | | particle size | | | | Added | |
| | | | constituent monomer | | | | Surface | amount*² | Median | of 70 μm | | | Median | amount*³ | Surface |
| | | | (° C.) | | | | tension | (parts by | diameter | or less | Producing | | diameter | (parts by | tension |
| | | Type | Formula (1) | Formula (2) | Formula (3) | Type | (mN/m) | mass) | (D50; μm) | (volume %) | method | Type | (D50; μm) | mass) | (mN/m) |
| Comparative | 1-1 | Comparative | 15 | 35 | 110*¹ | Nonionic | 36.1 | 0.8 | 184.8 | 4.90 | Spray drying | Inorganic | 17.3 | 7 | 46.1 |
| example | | copolymer 1 | | | | surfactant 1 | | | | | method | powder 1 | | | |
| | 1-2 | Copolymer 1 | 15 | 61 | — | Nonionic | 36.1 | 0.8 | 85.1 | 8.90 | Spray drying | Inorganic | 17.3 | 7 | 42.6 |
| | | | | | | surfactant 1 | | | | | method | powder 1 | | | |
| | 1-3 | | | | | Nonionic | 36.1 | 0.8 | 117.2 | 16.80 | Drum drying | Inorganic | 17.3 | 7 | 43.0 |
| | | | | | | surfactant 1 | | | | | method | powder 1 | | | |
| | 1-4 | | | | | Nonionic | 36.1 | 0.8 | 113.7 | 4.44 | Spray drying | Comparative | 94.2 | 7 | 43.1 |
| | | | | | | surfactant 1 | | | | | method | inorganic | | | |
| | | | | | | | | | | | | powder 1 | | | |
| | 1-5 | | | | | Nonionic | 36.1 | 0.8 | 809.0 | 0 | Spray drying | Inorganic | 17.3 | 7 | 42.7 |
| | | | | | | surfactant 1 | | | | | method | powder 1 | | | |
| | 1-6 | | | | | Nonionic | 32.2 | 0.8 | 81.5 | 8.01 | Spray drying | Inorganic | 17.3 | 7 | 38.9 |
| | | | | | | surfactant 2 | | | | | method | powder 1 | | | |
| | 1-7 | | | | | Comparative | 50.9 | 0.8 | 140.5 | 7.17 | Spray drying | Inorganic | 17.3 | 7 | 50.4 |
| | | | | | | nonionic | | | | | method | powder 1 | | | |
| | | | | | | surfactant 1 | | | | | | | | | |
| Example | 1-1 | Copolymer 1 | 15 | 61 | — | Nonionic | 36.1 | 0.8 | 113.7 | 4.44 | Spray drying | Inorganic | 17.3 | 7 | 42.1 |
| | | | | | | surfactant 1 | | | | | method | powder 1 | | | |
| | 1-2 | | | | | Nonionic | 36.1 | 0.8 | 113.7 | 4.44 | Spray drying | Inorganic | 38.5 | 7 | 41.9 |
| | | | | | | surfactant 1 | | | | | method | powder 2 | | | |
| | 1-3 | | | | | Nonionic | 36.1 | 0.8 | 185.9 | 1.02 | Spray drying | Inorganic | 17.3 | 7 | 41.6 |
| | | | | | | surfactant 1 | | | | | method | powder 1 | | | |
| | 1-4 | | | | | Nonionic | 36.1 | 0.8 | 277.1 | 6.55 | Drum drying | Inorganic | 17.3 | 7 | 42.0 |
| | | | | | | surfactant 1 | | | | | method | powder 1 | | | |
| | 1-5 | | | | | Nonionic | 36.1 | 0.1 | 111.2 | 6.36 | Spray drying | Inorganic | 17.3 | 7 | 47.1 |
| | | | | | | surfactant 1 | | | | | method | powder 1 | | | |
| | 1-6 | | | | | Nonionic | 36.1 | 2.0 | 125.9 | 3.36 | Spray drying | Inorganic | 17.3 | 7 | 39.9 |
| | | | | | | surfactant 1 | | | | | method | powder 1 | | | |
| | 1-7 | | | | | Nonionic | 32.2 | 0.8 | 120.4 | 5.88 | Spray drying | Inorganic | 17.3 | 7 | 36.2 |
| | | | | | | surfactant 2 | | | | | method | powder 1 | | | |
| | 1-8 | Copolymer 2 | 12 | 55 | — | Nonionic | 36.1 | 0.8 | 117.2 | 7.85 | Spray drying | Inorganic | 17.3 | 7 | 49.7 |
| | | | (acrylic acid) | | | surfactant 1 | | | | | method | powder 1 | | | |
| | | | 15 | | | | | | | | | | | | |
| | | | (methacrylic acid) | | | | | | | | | | | | |
| | 1-9 | Copolymer 3 | 12 | 55 | −75 | Nonionic | 36.1 | 0.8 | 119.1 | 7.32 | Spray drying | Inorganic | 17.3 | 1 | 48.4 |
| | | | (acrylic acid) | | | surfactant 1 | | | | | method | powder 1 | | | |
| | | | 15 | | | | | | | | | | | | |
| | | | (methacrylic acid) | | | | | | | | | | | | |

1 For convenience, shown in this column for the formula (3) is the melting point of the polyamide polyamine before an addition reaction with ethyleneoxide to obtain compound A-1 (compound A-1 of JP-B 3336456) used for the production of copolymer 1 in Table 1 of WO-A 2006/059723. While the above compound A-1 is obtained by carrying out an addition reaction of 2.0 mol of ethyleneoxide with the polyamide polyamine, the addition of ethyleneoxide in this amount does not cause a significant change in the melting points, and thus, the melting point of the polyamide polyamine can be considered as the melting point of compound A-1.
2 An added amount of component (A2) is expressed as a part by mass relative to 100 parts by mass of component (A1).
3 An added amount of particle (B) is expressed as a part by mass relative to 100 parts by mass of particle (A).

TABLE 2

| | | Temperature | | |
|---|---|---|---|---|
| | | 120° C. | 130° C. | Mortar test |
| | | Sieve passage | Sieve passage | Mortar flow |
| | | rate (%) | rate (%) | (mm) |
| Comparative | 1-1 | 98.3 | 98.3 | 178 |
| example | 1-2 | 13.8 | 6.0 | 298 |
| | 1-3 | 68.3 | 15.6 | 295 |
| | 1-4 | 68.9 | 20.1 | 299 |
| | 1-5 | 15.8 | 0.0 | 273 |
| | 1-6 | 70.8 | 23.3 | 298 |
| | 1-7 | 45.2 | 9.9 | 283 |
| Example | 1-1 | 98.7 | 98.8 | 313 |
| | 1-2 | 98.4 | 97.9 | 309 |
| | 1-3 | 99.8 | 99.0 | 312 |
| | 1-4 | 99.7 | 99.8 | 315 |
| | 1-5 | 91.9 | 55.5 | 310 |
| | 1-6 | 98.9 | 93.2 | 300 |
| | 1-7 | 89.6 | 98.6 | 301 |
| | 1-8 | 99.8 | 95.2 | 320 |
| | 1-9 | 91.4 | 61.9 | 250 |

The compositions of examples 1-1, 1-3, 1-4 and 1-7 had a sieve passage rate of more than 90 even if caking tests were conducted in the same manner as above with the temperature further raised to 140° C.

1. A powder dispersant composition for hydraulic compositions, the powder dispersant composition comprising the following particles (A) and (B), wherein
an aqueous solution or aqueous suspension of the powder dispersant composition for hydraulic compositions at a concentration of 5 mass % has a surface tension of 20.0 mN/m or more and 50.0 mN/m or less at 25° C.,
particles (A) are particles containing the following components (A1) and (A2) and having a median diameter of 90.0 μm or more and 600.0 μm or less, wherein a proportion of particles with a particle size of 70 μm or less is 15.0 volume % or less,
component (A1) is a copolymer including a constituent unit (1) represented by the following formula (1) and a constituent unit (2) represented by the following formula (2), wherein all raw material monomers of the copolymer have a melting point of −80° C. or more and 80° C. or less: 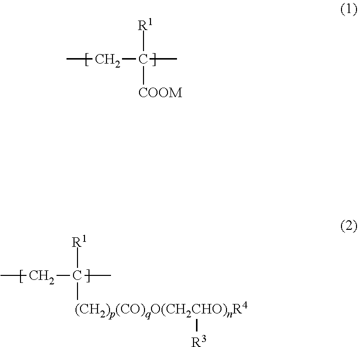
wherein R¹ and R³ are the same or different and each represent a hydrogen atom or a methyl group, R² and R⁴ are the same or different and each represent a hydrogen atom or an alkyl group with 1 or more and 3 or less carbons, M represents a hydrogen atom, an alkali metal, an alkaline earth metal, ammonium or an organic ammonium, p represents a number of 0 or more and 2 or less, q represents a number of 0 or 1, and n represents an average number of added moles and represents a number of 5 or more and 150 or less,
component (A2) is a nonionic surfactant whose aqueous solution or aqueous suspension at a concentration of 5 mass % has a surface tension of 20.0 mN/m or more and 50.0 mN/m or less at 25° C., and
particles (B) are particles formed of an inorganic compound and having a median diameter of 1.0 μm or more and 50.0 μm or less.

2. A powder dispersant composition for hydraulic compositions, the powder dispersant composition comprising the following particles (A) and (B), wherein
an aqueous solution or aqueous suspension of the powder dispersant composition for hydraulic compositions at a concentration of 5 mass % has a surface tension of 20.0 mN/m or more and 50.0 mN/m or less at 25° C.,
particles (A) are particles containing the following components (A1) and (A2) and having a median diameter of 90 μm or more and 600 μm or less, wherein a proportion of particles with a particle size of 70 μm or less is 15 volume % or less,
component (A1) is a copolymer including a constituent unit (1) represented by the following formula (1) and a constituent unit (2) represented by the following formula (2), wherein all raw material monomers of the copolymer have a melting point of −80° C. or more and 80° C. or less: 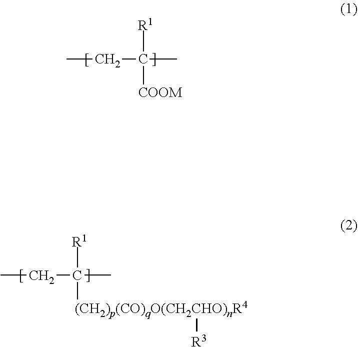
wherein R¹ and R³ are the same or different and each represent a hydrogen atom or a methyl group, R² and R⁴ are the same or different and each represent a hydrogen atom or an alkyl group with 1 or more and 3 or less carbons, M represents a hydrogen atom, an alkali metal, an alkaline earth metal, ammonium or an organic ammonium, p represents a number of 0 or more and 2 or less, q represents a number of 0 or 1, and n represents an average number of added moles and represents a number of 5 or more and 150 or less,
component (A2) is a nonionic surfactant whose aqueous solution or aqueous suspension at a concentration of 5 mass % has a surface tension of 20.0 mN/m or more and 50.0 mN/m or less at 25° C., and
particles (B) are particles formed of an inorganic compound and having a median diameter of 1 μm or more and 50 μm or less.

3. The powder dispersant composition according to claim 1, wherein the aqueous solution or aqueous suspension of the powder dispersant composition at a concentration of 5 mass % has a surface tension of 35 mN/m or more and 50.0 mN/m or less at 25° C.

4. The powder dispersant composition according to claim 1, wherein the particle (A) has a median diameter of 100 μm or more and 450 μm or less.

5. The powder dispersant composition according to claim 1, wherein the particle (A) includes particles with a particle size of 70 μm or less in a proportion of 0.5 volume % or more and 9 volume % or less.

6. The powder dispersant composition according to claim 1, wherein all the raw material monomers of the component (A1) have a melting point of −80° C. or more and 65° C. or less.

7. The powder dispersant composition according to claim 1, wherein the particle (B) is a particle selected from the group consisting of silica powder, calcium carbonate powder, and calcium silicate powder.

8. The powder dispersant composition according to claim 1, wherein the particle (B) has a median diameter of 10 μm or more and 40 μm or less.

9. The powder dispersant composition according to claim 1, wherein the component (A1) optionally further comprises a constituent unit (3) represented by the following formula (3); and, with respect to a total content of the constituent units (1) to (3), a proportion of the constituent unit (1) is 45 mol % or more and 95 mol % or less, a proportion of the constituent unit (2) is 5 mol % or more and 30 mol % or less, and a proportion of the constituent unit (3) is 0 mol % or more and 35 mol % or less; 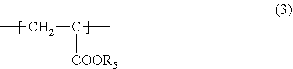
wherein R⁵ represents a hydrocarbon group with 1 or more and 4 or less carbons which may include hetero atoms.

10. The powder dispersant composition according to claim 1, wherein an amount of the particle (B) in the powder dispersant composition is 0.1 parts by mass or more and 15 parts by mass or less relative to 100 parts by mass of the component (A1) in the particle (A).

11. The powder dispersant composition according to claim 1, wherein a part by mass of a content of the component (A2) relative to 100 parts by mass of a content of the component (A1) in the particle (A) is 0.1 parts by mass or more and 2.0 parts by mass or less.

12. A premix for hydraulic compositions formulated with the powder dispersant composition according to claim 1; one or more hydraulic powders selected from the group consisting of cement, gypsum, slag, fly ash, and lime; and a fine aggregate.

13. A hydraulic composition formulated with the premix for hydraulic compositions according to claim 12 and water.

14. A method for producing the powder dispersant composition according to claim 1, the method comprising:
drying a mixture containing the component (A1), the component (A2), and water to produce the particle (A), and
mixing the particle (A) with the particle (B).

15-16. (canceled)

17. A method for producing a premix for hydraulic compositions, the method comprising:
mixing the powder dispersant composition according to claim 1; one or more hydraulic powders selected from the group consisting of cement, gypsum, slag, fly ash, and lime; and a fine aggregate.

18. A method for producing a hydraulic composition, the method comprising:
mixing the premix for hydraulic compositions according to claim 12 with water.
